(19) United States
(12) Patent Application Publication
(10) Pub. No.: US 2008/0230488 A1
(43) Pub. Date: Sep. 25, 2008

(54) Pleated, Crossflow Fluid Treatment Elements, Methods for Making Them, and Methods for Treating Cellular Solutions

(75) Inventors: Richard G. Gutman, West Sussex (GB); Richard Martin, Hampshire (GB); Nigel Cook, North Devon (GB); Kenneth Weight, Hampshire (GB)

Correspondence Address: LEYDIG VOIT & MAYER, LTD, 700 THIRTEENTH ST. NW, SUITE 300, WASHINGTON, DC, 20005-3960, US

(73) Assignee: Pall Corporation, East Hills, NY (US)

(21) Appl. No.: 10/593,642

(22) PCT Filed: Mar. 28, 2005
(86) PCT No.: PCT/US05/10307

§ 371 Date: Sep. 21, 2006

Related U.S. Application Data
(60) Provisional application No. 60/556,891, filed on Mar. 29, 2004.
(60) Provisional application No. 60/648,394, filed on Feb. 1, 2005.

(51) Int. Cl. B01D 37/00; B01D 27/06; B28B 1/14

(52) U.S. Cl. 210/767; 210/493.2; 210/493.1; 264/299

(57) ABSTRACT

Fluid treatment elements and methods for treating fluids may be used to treat fluids, including gases, liquids, or mixtures of gases, and/or solids, in a crossflow mode of operation. For example, some fluid treatment elements and methods may be used to remove one or more substances from the fluid and may then function as concentrators or filters or separators. Other fluid treatment elements or methods may be used to transfer substances between two fluid streams and may then function as mass transfer devices.

### CROSS-REFERENCE TO RELATED APPLICATIONS

This application claims priority based on U.S. Provisional Application No. 60/556,891, filed on Mar. 29, 2004, and U.S. Provisional Application No. 60/648,394, filed on Feb. 1, 2005, both of which are incorporated by reference.

### DISCLOSURE OF THE INVENTION

The present invention relates to fluid treatment elements which may be used to treat fluids, including gases, liquids, or mixtures of gases, liquids and/or solids, in a wide variety of ways. For example, some of the fluid treatment elements may be used to remove one or more substances from the fluid and may then function as concentrators or filters or separators. Others of the fluid treatment elements may be used to transfer substances between two fluid streams and may then function as mass transfer devices.

In particular, the present invention relates to pleated fluid treatment elements which are structured to treat a fluid in a crossflow mode of operation. The pleated fluid treatment elements may include a single sheet or a multilayer composite having a fluid treatment medium. The single sheet or the multilayer composite may be folded or corrugated in a zigzag fashion to create several pleats. Each pleat has a folded end, an open end and two legs that extend between the folded end and the open end. The opposite end edges of the pleated sheet or composite are sealed to one another to form a generally cylindrical fluid treatment pack with each pleat extending generally axially along the fluid treatment pack.

The pleated, crossflow fluid treatment elements may include a first fluid flow path that passes tangentially along the pleats of the fluid treatment pack and a second fluid flow path that passes through the pleated fluid treatment medium from or to the first fluid flow path. For example, feed fluid may enter the fluid treatment element along the first fluid flow path. The feed fluid then passes via the first fluid flow path axially along the fluid treatment pack and tangentially within the pleats of the pack, where the feed fluid is treated. For example, one or more substances, including one or more constituents of the feed fluid, may be removed from the feed fluid by passing out of the feed fluid along the second fluid flow path through the fluid treatment medium. Alternatively, one or more substances may be added to the feed fluid by passing into the feed fluid along the second fluid flow path through the fluid treatment medium. The treated feed fluid then continues along the first fluid flow path out of the fluid treatment element.

In accordance with one aspect of the invention, fluid treatment elements embodying the invention may comprise a fluid treatment pack, a spacer arrangement, and first and second fluid flow paths. The fluid treatment pack includes a fluid treatment medium, an axis, first and second opposite ends, and a plurality of pleats which extend axially between the first and second ends of the pack. Each pleat has a folded end, an open end, and first and second legs which extend between the folded end and the open end. The spacer arrangement is associated with the pleats to define a first region within each pleat which is occupied by the spacer arrangement and a second region within each pleat which is substantially free of structure. The first fluid flow path extends axially along the pleated fluid treatment pack within the pleats and includes the second region of each pleat. The second fluid flow path extends through the pleated fluid treatment medium from or to the first fluid flow path.

In accordance with another aspect of the invention, fluid treatment elements embodying the invention may comprise a hollow, generally cylindrical fluid treatment pack, a spacer arrangement, and first and second end caps. The fluid treatment pack includes an axis, an interior, first and second opposite ends, and a pleated composite. The pleated composite defines a plurality of pleats extending axially between the first and second ends of the fluid treatment pack. Each pleat has a folded outer end, an open inner end, and first and second legs first extending between the folded outer end and the open inner end. The pleated composite includes a fluid treatment medium having an inner surface and an outer surface and a drainage medium positioned along the outer surface of the fluid treatment medium. The spacer arrangement is associated with the pleats of the fluid treatment pack inwardly from the inner surface of the fluid treatment medium. The spacer arrangement includes a first spacer positioned proximate the first end of the fluid treatment pack, a second spacer positioned proximate the second end of the fluid treatment pack, and a region which extends axially along each pleat between the first and second spacers and which is substantially free of structure. The core arrangement is positioned in the hollow interior of the fluid treatment pack and includes a blind portion axially spaced from the first end and the second end of the fluid treatment pack. The blind portion resists fluid flow radially inwardly from the axially extending regions of the fluid treatment pack. The first and second end caps are respectively sealed to the first and second ends of the fluid treatment pack, and each end cap has a central opening which fluidly communicates with the axially extending regions of the pleats.

In accordance with another aspect of the invention, fluid treatment elements embodying the invention may comprise a generally cylindrical fluid treatment pack, a spacer arrangement, an outer surround, and first and second end caps. The fluid treatment pack includes an axis, an interior and an exterior, first and second opposite ends, and a pleated composite. The pleated composite defines a plurality of pleats extending axially between the first and second ends of the fluid treatment pack. Each pleat has a folded inner end, an open outer end, and first and second legs extending between the folded inner end and the open outer end. The pleated composite includes a fluid treatment medium having an inner surface and an outer surface and a drainage medium positioned along the inner surface of the fluid treatment medium. The spacer arrangement is associated with the pleats of the fluid treatment pack outwardly from the outer surface of the fluid treatment medium. The spacer arrangement includes a first spacer positioned proximate the first end of the fluid treatment pack, a second spacer positioned proximate the second end of the fluid treatment pack, and a region which extends axially along each pleat between the first and second spacers and which is substantially free of structure. The outer surround is positioned around the exterior of the fluid treatment pack and includes a blind portion axially spaced from the first and second ends of the fluid treatment pack. The blind portion of the outer surround resists fluid flow radially outwardly from the axially extending regions of the fluid treatment pack. The first and second end caps are respectively sealed to the first and second ends of the fluid treatment pack, and each end cap has a central opening which fluidly communicates with the interior of the fluid treatment pack.

In accordance with another aspect of the invention, methods of making a fluid treatment element embodying the invention may comprise corrugating a fluid treatment medium to form a plurality of axially extending pleats. Each pleat has a folded end, an open end, and first and second legs extending between the folded end and the open end. The method further comprises forming the plurality of pleats into a generally cylindrical fluid treatment pack, the pleats extending axially along the fluid treatment pack. The method further comprises positioning a spacer arrangement between the legs of the pleats. The spacer arrangement spaces the legs apart and defines a region within each pleat that extends axially and is substantially free of structure. The method further comprises sealing the first and second ends of the fluid treatment pack to form a first fluid flow path and a second fluid flow path. The first fluid flow path extends axially along the fluid treatment pack via the regions which are substantially free of structure. The second fluid flow path extends through the fluid treatment pack from or to the first fluid flow path.

In accordance with another aspect of the invention, a method of making a fluid treatment element embodying the invention may comprise corrugating a composite to form a plurality of pleats. The composite includes a fluid treatment medium having first and second opposite side edges and first and second opposite surfaces, a drainage medium positioned along the first surface of the fluid treatment medium, a spacer positioned along the second surface of the fluid treatment medium proximate the first side edge and a material positioned along the second surface of the fluid treatment medium. The method further comprises forming the corrugated composite into a generally cylindrical fluid treatment pack having first and second ends, where the pleats extend axially along the fluid treatment pack. The method further comprises stripping the material from the corrugated composite to form a region within each pleat that is substantially free of structure. The method further comprises sealing the first and second ends of the fluid treatment packs to form a first fluid flow path and a second fluid flow path. The first fluid flow path extends axially along the fluid treatment pack via the regions which are substantially free of structure and the second fluid flow path extends through the fluid treatment pack from or to the first fluid flow path.

Embodiments of the invention may be configured in a variety of ways. For example, for some embodiments, the spacer arrangement may be associated with the pleats in a manner that positions the spacer arrangement between the legs of the pleats. For other embodiments, the spacer arrangement may be associated with the pleats in a manner that positions the spacer arrangement within the legs of the pleats, for example, between the fluid treatment medium and an additional porous medium, such as a drainage medium. For most embodiments, the spacer arrangement defines a region substantially free of structure that is located directly next to, i.e., adjoins, a surface of the fluid treatment medium.

Embodiments of the invention provide many advantages over conventional fluid treatment elements. For example, by providing regions within the pleats that are substantially free of structure, feed fluid can flow along these regions with less resistance to fluid flow. Consequently, feed fluid may flow tangentially through the fluid treatment pack with less pressure drop. Further, by locating the regions substantially free of structure directly next to the surface of the fluid treatment medium, fluid flowing along the tangential flow path through these regions can more thoroughly clear foulants from the surface of the fluid treatment medium. Consequently, the service life of the fluid treatment elements can be extended. In addition, many feed fluids are subject to damage when they flow through or around structures in the fluid flow path. For example, when a feed solution containing cells and/or cellular components flows through a porous netting, many cells may be disrupted, destroying the cells and contaminating the solution with cellular debris. By providing regions within the pleats that are substantially free of structure, embodiments of the invention allow feed fluid to flow tangentially along the fluid treatment pack with little or no damage.

Thus, in accordance with another aspect of the invention, a method for treating a cellular solution comprises passing the cellular solution axially along a pleated fluid treatment element within the pleats. Passing the cellular solution axially within the pleats includes directing the cellular solution axially along regions between the legs of the pleats that are substantially free of structure. The method further comprises passing one or more substances through a fluid treatment medium of the fluid treatment element from or to the cellular solution in the regions substantially free of structure.

Embodiments in which the spacer arrangement is positioned between the fluid treatment medium and an additional porous medium, e.g., a drainage medium, offer additional advantages. In these embodiments, fluid flowing axially along the pleats via the first fluid flow path flows mostly along the regions substantially free of structure but partly along the additional porous medium. During normal modes of operation, the fluid in the first fluid flow path on one side of the fluid treatment medium is generally at a higher pressure than the fluid on the opposite side of the fluid treatment medium. The higher pressure fluid keeps adjacent legs of each pleat spaced from each other and the regions substantially free of structure open to fluid flow. There may be instances when the pressure of the fluid in the first fluid flow path falls below the pressure of the fluid on the opposite side of the fluid treatment medium. Adjacent pleat legs may then expand toward each other, collapsing and pinching off all or some portion of the regions substantially free of structure. However, when the normal mode of operation resumes and the fluid pressure in the first fluid flow path is again greater than the fluid pressure on the opposite side of the fluid treatment medium, the regions free of structure can be immediately reestablished. The higher pressure fluid easily flows along the first fluid flow path within each pleat via the additional porous medium, where it forces the adjacent legs of each pleat back to their normal spaced position and reopens the regions substantially free of structure.

### BRIEF DESCRIPTION OF THE DRAWINGS

FIG. 1 is a view of a fluid treatment element which is partially sectioned as shown in FIG. 2.

FIG. 2 is a partial section view of the foreground of a fluid treatment element showing regions that are substantially free of structure.

FIG. 3 is a partial section view of the fluid treatment element showing a spacer arrangement.

FIG. 4 is a representational view of a portion of a system for making the fluid treatment element.

FIG. 5 is an oblique view of a fluid treatment pack and a side seal.

FIG. 6 is a partial section view of another fluid treatment element showing regions substantially free of structure.

FIG. 7 is a partial section view of the fluid treatment element of FIG. 6 showing a spacer arrangement.

FIG. 8 is a representational view of a system for making the fluid treatment element of FIG. 6.

FIG. 9 is a partially sectioned view of a fluid treatment assembly.

FIG. 10 is a plan view of a fluid treatment element showing a surround.

FIG. 11 is an end view of a core arrangement and a spacer arrangement.

FIG. 12 is a view of a fluid treatment assembly which is partially sectioned as shown in FIG. 13.

FIG. 13 is a partial sectional view of the foreground of a fluid treatment element showing regions that are substantially free of structure.

FIG. 14 is a partial sectional view of the fluid treatment element of FIG. 13 showing a spacer arrangement.

### DESCRIPTION OF EMBODIMENTS

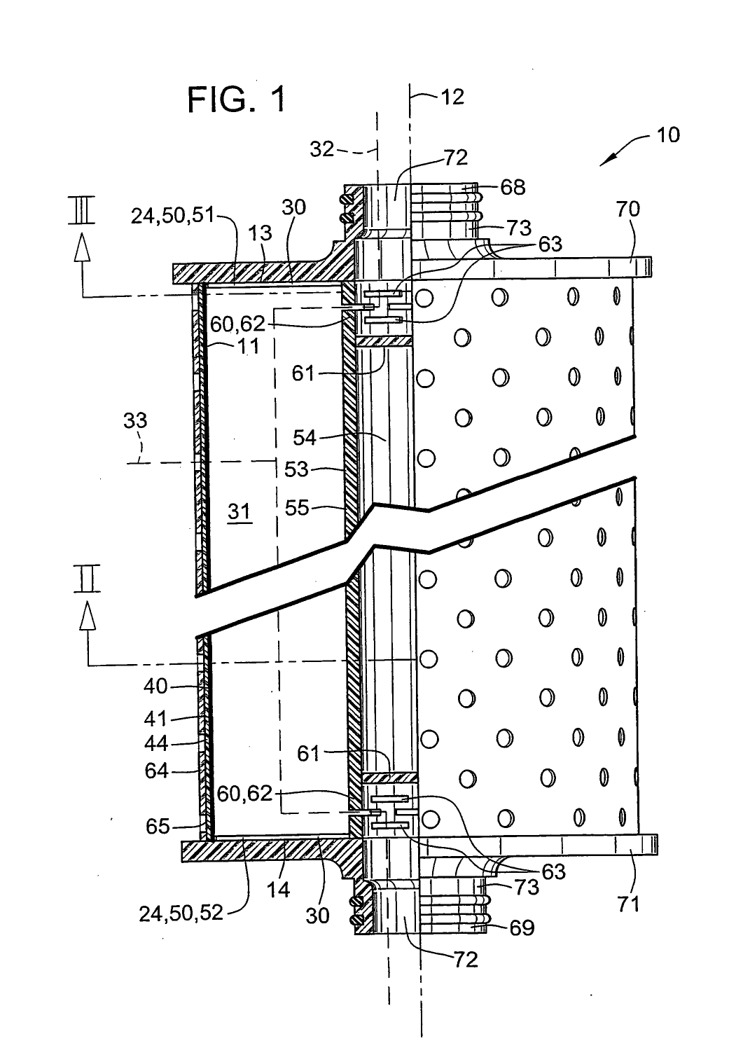

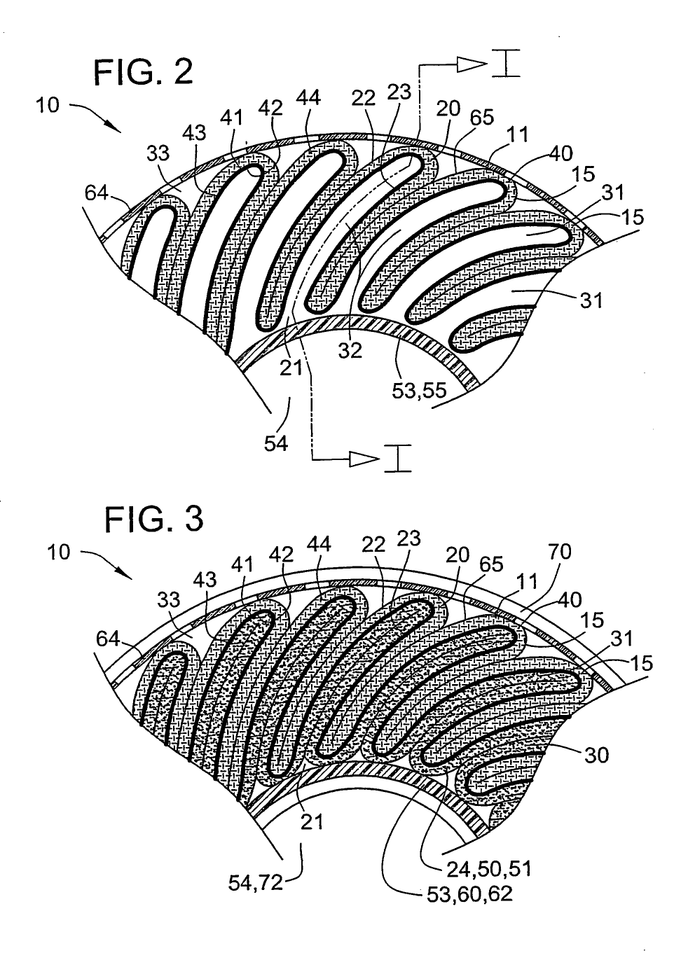

Many different fluid treatment elements may embody the invention. An example of one fluid treatment element 10 embodying the invention is shown in FIGS. 1-3. The fluid treatment element 10 generally includes a fluid treatment pack 11 having an axis 12, opposite ends 13, 14, a fluid treatment medium, and a plurality of pleats 15. The pleats 15 extend generally axially between the ends 13, 14 of the pack 11, and each pleat 15 generally includes a folded end, e.g., a folded outer end 20, an open end, e.g., an open inner end 21, and two legs 22, 23 which extend between the folded end 20 and the open end 21. A spacer arrangement may be associated with the pleats of the fluid treatment pack in any of a variety of ways. For example, a spacer arrangement 24 may be positioned between the legs 22, 23 of each pleat 15 to space the legs 22,23 apart. The spacer arrangement 24 defines a region 30 within the pleat 15, e.g., between the legs 22, 23 of the pleat 15, that is occupied by the spacer arrangement 24 and another region 31 within the pleat 15, e.g., between the legs 22, 23 of the pleat 15, that is substantially free of structure. The spacer arrangement may be associated with a plurality of pleats, including some, most, or all of the pleats, to define regions substantially free of structure. For example, the spacer arrangement may define regions substantially free of structure in up to about 40% or more of the pleats, including at least about 60%, at least about 80%, at least about 90%, or at least about 95% of the pleats, or all of the pleats. Greater percentages are preferred because they provide more regions substantially free of structure within the pleats of the fluid treatment element. The fluid treatment element 10 further includes a tangential fluid flow path 32 and a lateral fluid flow path 33. The tangential fluid flow path 32 extends generally axially along the fluid treatment pack 11 within the pleats 15, including the regions 31 that are substantially free of structure. The lateral fluid flow path 33 fluidly communicates with the tangential fluid flow path 32 and extends laterally through the fluid treatment medium to or from the tangential fluid flow path 32.

In operation, feed fluid may pass tangentially along the fluid treatment pack 11 via the tangential fluid flow path 32. The feed fluid within the regions 31 that are substantially free of structure may be treated by removing one or more substances from the feed fluid via the lateral fluid flow path 33 through the fluid treatment medium or by adding one or more substances to the feed fluid via the lateral fluid flow path 33 through the fluid treatment medium. The fluid treatment element 10 may thus be considered a pleated, crossflow fluid treatment element. International Publication No. WO 00/13767 also discloses pleated, crossflow fluid treatment elements and is incorporated by reference in its entirety.

The fluid treatment pack 11 may be structured in a wide variety of ways. For example, the fluid treatment pack may be a pleated, single-layer sheet (not shown) or may include a pleated, multilayered composite 40. Some or all of the layers of the composite 40 may be integrally joined to or formed with one another. However, in many embodiments, the layers of the composite 40 comprise separate layers positioned adjacent to one another.

The fluid treatment pack 11 includes a fluid treatment medium 41, for example, as a single sheet or a region of a single sheet or as one or more of the layers of a composite 40. The fluid treatment medium 41 may have opposite surfaces, e.g., an inner surface 42 and an outer surface 43. Suitable fluid treatment media may vary widely depending on such factors as the nature of the feed fluid and how the feed fluid is to be treated. For example, the fluid treatment medium may have, or may be modified to have, any of a myriad of properties. The fluid treatment medium may be porous, permeable or semipermeable and may have removal efficiencies from the Angstrom or Dalton range or less, through the submicron range, to the micron or tens of microns range or more. For example, the fluid treatment medium may comprise a nanofiltration, an ultrafiltration, or a microfiltration medium. The fluid treatment may allow gas and liquid to pass through it or just gas and not liquid. The fluid treatment medium may be liquiphobic or liquiphilic, may have an electrically neutral or charged surface, and/or may include one or more functional groups which may, for example, be arranged to bind to one or more substances in the feed fluid. The fluid treatment medium may be configured in a variety of ways, including, for example, as a membrane or a fibrous sheet, and may be formed from any suitable material, including metal, natural or synthetic polymers, or a ceramic or glass. For many embodiments, a polymeric filtration membrane having a submicron removal rating may be used as the fluid treatment medium.

The fluid treatment pack 11 may include one or more porous media in addition to the fluid treatment medium 41. For example, the fluid treatment pack 11 may include a porous drainage medium, e.g., as a region of a single sheet or as another layer of the multilayer composite 40. The drainage medium 44 may be positioned along at least one surface, e.g., the outer surface 43, of the fluid treatment medium 41 either adjoining the surface, or spaced from the surface, of the fluid treatment medium. The drainage medium 44 may comprise any of a variety of materials having a sufficiently low edgewise flow resistance to enable fluid to adequately flow to or from the surface of the pleated fluid treatment medium. Many suitable drainage axially media are disclosed, for example, in U.S. Pat. No. 5,543,047 and U.S. Pat. No. 5,252,207, both of which are incorporated by reference in their entirety. For many embodiments, a woven or nonwoven polymeric material or a polymeric mesh may be used as the drainage medium. For example, the drainage material may comprise a mesh having first and second sets of strands, e.g., machine direction strands and cross direction strands. Either set of strands, or neither set of strands, may be oriented within the composite parallel to the pleats.

A multilayer composite 40 may include other porous media layers. For example, the drainage medium 44 may be positioned along the outer surface 43 of the fluid treatment medium 41 with a cushioning layer (not shown) between them. The cushioning layer protects the fluid treatment medium 41 from abrasion by the drainage medium 44, as disclosed in U.S. Pat. No. 5,252,207. As another example, if the fluid treatment medium 41 is flimsy, a support medium (not shown) may be positioned along a surface of the fluid treatment medium 41, for example, along the surface opposite the drainage medium 44, e.g., along the inner surface 42. Many of the stiffer drainage media may be used as a support medium, which more rigidly supports the fluid treatment medium 41.

The spacer arrangement may also be structured in a wide variety of ways and may be incorporated in the composite or may be distinct from the composite. For example, the spacer arrangement may comprise one or more spacers associated with the pleats of the fluid treatment pack. In the illustrated embodiment, the spacers 50 may be positioned within the pleats, e.g., between the legs 22,23 of each pleat 15 to space the legs 22,23 apart. The spacer may have a variety of configurations. For example, the spacer may comprise a plurality of pads, each pad being inserted within a pleat. Alternatively, the spacer 50 may comprise one or more strips 51,52 of material which extend along and are pleated with the single sheet or the multiple layers of the composite 40, the strips being incorporated in the composite.

The thickness of the spacer arrangement 24, e.g., the spacers including the strips or the pads, generally corresponds to the thickness of the regions 31 that are substantially free of structure and may be selected in accordance with desired number of pleats and the desired size of each region substantially free of structure. For some embodiments, the thickness of the spacer arrangement 24 may be in the range from about 0.05 mm or less to about 5 mm or more or in the range from about 0.1 mm to about 2.0 mm or in the range from about 0.1 mm to about 1 mm, e.g., about 0.5 mm. Various widths are suitable for the spacer arrangement 24. For example, the width may be in the range from about 3 mm or less to about 20 mm or more, e.g., from about 5 mm to about 10 mm. The height of the spacer arrangement 24 may be at least about 25%, or at least about 50%, or at least about 80%, or at least about 95%, or about 100% of the height of the pleat.

The spacer arrangement may be arranged along one or both surfaces of the fluid treatment medium. For example, the spacer arrangement may be positioned only along one surface. In the embodiment illustrated in FIGS. 1-3, the spacer arrangement 24 may be positioned along the surface of the fluid treatment medium 41 opposite the drainage medium 44, e.g., along the inner surface 42. The spacer arrangement may also be positioned at various axial locations along the fluid treatment pack. For example, the spacer arrangement may be positioned along only one end of the fluid treatment pack. Thus, the spacer arrangement may be only one strip of material, and the strip may be pleated along one end of the fluid treatment pack between the legs of the pleats. Alternatively, the spacer arrangement 24 may be positioned only along both ends of the fluid treatment pack 11, as shown in FIGS. 1-3. Thus, the spacer arrangement 24 may be only two strips 51,52 of material, and the strips 51,52 may be pleated along each end 13,14 of the fluid treatment pack 11, for example, between the legs 22,23 of the pleats 15. Alternatively, the spacer arrangement may include three or more strips of material. Spacers may be positioned at axial locations spaced from the ends of the fluid treatment pack, e.g., in the middle of the pack or at multiple intervals along the axial length of the fluid treatment pack.

The spacer arrangement may be formed from a material which resists compression, and the material may be channeled or perforated or porous or may be impermeable, depending on factors such as the location of the spacer arrangement. For example, a spacer arrangement may comprise a spacer located at an end of the fluid treatment pack. If that end of the fluid treatment pack at the spacer is sealed against fluid flow, for example, by an end cap or a sealant, the spacer material may be channeled, perforated, porous, or impervious. If the end of the fluid treatment pack at the spacer is not sealed against fluid flow, the spacer material may be channeled, perforated or porous to allow fluid to flow into or out of the regions free of structure within the pleats. Spacers which are positioned at locations spaced from the ends of the fluid treatment pack may also be channeled, perforated or porous to allow fluid flow axially along the regions free of structure within the pleats. For many embodiments, spacer arrangements formed from material having a low edgewise flow resistance, as disclosed for various drainage media in U.S. Pat. No. 5,543,047, are suitable.

The spacer arrangement 24 defines a region 30 within each pleat which is occupied by the spacer material and another region 31 which is substantially free of structure. To increase the size of the region 31 substantially free of structure, the size of the spacer region 30 may be small. For example, the total width of the region 30 occupied by the spacer arrangement 24 may be less than about 20%, or less than about 10%, or less than about 5%, or less than about 3%, or less than about 1%, of the axial length of the fluid treatment pack 11. Further, the region 31 within each pleat 15 that is substantially free of structure may have some structure in the region, but at least about 50%, or at least about 70%, or at least about 90%, or at least about 95%, or 100% of the region 31 is completely free of structure. For many preferred embodiments, the fluid treatment elements 10 have smaller spacer regions 30, e.g., spacer regions 30 which are less than about 10% of the axial length, and less structure in the regions 31 which are substantially structure free, e.g., regions 31 which are at least about 95% completely free of structure. For some embodiments, each region 31 extends from one spacer at one end of the fluid treatment pack to the other spacer at the other end of the fluid treatment pack and is completely free of structure.

In addition to the fluid treatment pack 11 and the spacer arrangement 24, the fluid treatment element 10 may include other features. For example, the fluid treatment element 10 may include a core arrangement 53 positioned in the interior 54 of the hollow fluid treatment pack 11. The core arrangement 53 may be variously configured. For example, the core arrangement 53 may comprise a blind portion 55 which serves to block off the open inner ends 21 of the pleats 15 and/or resist, e.g., prevent, radially inward fluid flow from the regions 31 that are substantially free of structure. The blind portion 55 may terminate at locations spaced axially inwardly from one or both ends 13,14 of the fluid treatment pack 11. The blind portion 55 may be hollow or solid, may have a generally cylindrical outer surface that abuts the pleats 15, may be neither porous nor perforated, and may be without surface textures that would allow fluid to drain axially between the core arrangement 53 and the fluid treatment pack 11. Feed fluid flowing along the tangential fluid flow path 32 may thus be prevented from flowing radially inwardly from the regions 31 that are substantially free of structure.

The core arrangement 53 may also comprise an end portion 60 in the interior 54 of the fluid treatment pack 11. The end portion 60 may extend from each end of the blind portion 55 to an end 13,14 of the fluid treatment pack 11, or beyond, and a barrier 61 between the blind portion 55 and each end portion 60. Each end portion 60 may include a generally cylindrical side wall 62 which is porous or perforated and an opening 63 opposite the barrier 61. The barriers 61, which may be impervious, may serve to direct fluid flow between the interior of the end portions 60 and the regions 31 substantially free of structure via the open inner ends 21 of the pleats 15.

The core arrangement may be configured in many other ways. For example, the core arrangement may include the barriers and the blind portion but the end portions may be eliminated. The barriers may then direct fluid between the interior of the fluid treatment pack and the regions substantially free of structure via the open inner ends of the pleats. Alternatively or additionally, the core arrangement may include the barriers without the blind portion and the end portions. A sealant may be disposed along the open inner ends of the pleats in place of the blind portion, blocking off the open inner ends. As another alternative, the core arrangement may comprise a blind portion which extends through the interior of the fluid treatment pack to one or both ends of the fluid treatment pack. The spacers between the legs of the pleats at one or both ends of the fluid treatment pack may then be channeled or porous or perforated to allow fluid to pass through the spacer into or out of the regions 31 that are substantially free of structure.

In some embodiments, the core arrangement may be omitted. For example, a sealant may be applied along the interior of the fluid treatment pack, blocking off the open inner ends of the pleats. Alternatively or additionally, the pleats of the fluid treatment pack may be packed tightly enough that the spacers are compressed at the open inner ends of the pleats but are not compressed radially outwardly from the open inner ends. The open inner ends of the pleats may thus be pinched off without collapsing the regions that are substantially free of structure. With the core arrangement omitted, the spacers between the legs of the pleats at both ends of the fluid treatment pack may be porous or perforated to allow fluid to pass through the spacer into or out of the regions that are substantially free of structure.

The fluid treatment element 10 may also include a surround 64, such as a cage, a sleeve, and/or a wrap, positioned around the exterior 65 of the fluid treatment pack 11. The surround 64 may be porous or perforated, or may have other openings, along a portion or all of the axial length of the fluid treatment pack 11, allowing fluid to flow along the lateral fluid flow path 33. The surround may adjoin or abut the outer folded ends of the pleats and may hold the pleats in position.

The fluid treatment element 10 may also include a sealing mechanism at the ends 13,14 of the fluid treatment pack 11. The sealing mechanism seals the end, e.g., all or a portion of the end, of the fluid treatment pack to establish the tangential fluid flow path along the fluid treatment element and the lateral fluid flow path through the fluid treatment medium. Various mechanisms may be used to seal the ends 13,14. For example, the fluid treatment element 10 may include one or two end caps 70,71 respectively joined to one or both ends 13,14 of the fluid treatment pack 11. The end caps 70,71 may be formed from any suitably impervious material and may be joined to the ends 13,14 in any suitable manner which seals the ends 13,14. For example, the end caps may be melt bonded, welded, solvent bonded, or adhesively bonded, e.g., with a potting compound or a sealant, to the ends 13,14. For many embodiments, a spacer at the end of the fluid treatment pack may be joined to the end cap along with the end of the pack. Alternatively, the spacer may be positioned inwardly from the end of the pack and may not be joined to the end cap along with the end of the pack. The end caps may or may not be bonded to the core arrangement 53 and/or the surround 64.

The end caps may be configured in any suitable manner. In the embodiment illustrated in FIGS. 1-3, each end cap 70,71 comprises an open end cap which has an opening 72 that fluidly communicates with the interior 54 of the fluid treatment pack 11 and the respective opening 63 in the end portion 60 of the core arrangement 53. An end cap may be generally flat or may have a protrusion 73 that extends, for example, away from the fluid treatment pack. The protrusion may be unitarily formed with the end cap or may be a separate piece attached to the end cap. The protrusion may be configured as any of a wide variety of adapters or fittings that enable the fluid treatment element to be coupled to another component, e.g., a housing or another fluid treatment element. For example, the fitting on one end of the fluid treatment element 10 may comprise a feed or process fluid inlet fitting 68, while the fitting on the other end may comprise a concentrate a retentate outlet fitting 69. Alternatively, the adapters, fittings, inlet opening, and outlet opening may be configured as part of an end cap without a protrusion. One or both end caps may also include one or more seals, such as a gasket or an O-ring, for sealingly coupling the fluid treatment element to another component.

Alternatively or additionally, the end sealing mechanism may comprise a sealant, including, for example, an epoxy, a silicone or a polyurethane, applied to all or a portion of one or both ends of the fluid treatment pack. For example, a sealant may be applied to the drainage medium along the outer surface of the fluid treatment medium at one or both ends of the fluid treatment pack. The sealant may also be applied around the exterior of the fluid treatment pack at the one or both ends of the pack to form a gasket for sealing the fluid treatment element to another component. However, the sealant may not be applied along the inner surface of the fluid treatment pack at the one or both ends. The spacers between the legs of the pleats along the inner surface of the fluid treatment medium at the one or both ends of the fluid treatment pack may be channeled, porous or perforated to allow fluid to enter or exit the regions. Further, the interior of the fluid treatment may be completely blinded off, for example, by a core arrangement that has a blind portion extending through the interior of the fluid treatment pack from one end to the other. Fluid, e.g., feed fluid, may then flow into the fluid treatment pack along the tangential fluid flow path, e.g., through the spacers at one end, along the regions substantially free of structure and out of fluid treatment pack through the opposite spacers. The tangential fluid flow path and the lateral fluid flow path may then be separated by the sealant except via the fluid treatment medium.

The fluid treatment element may be made in any of several different ways. According to one general example, the fluid treatment medium, either as a single sheet or as part of a composite, may be corrugated to form a plurality of axially extending pleats. Any suitable type of corrugator may be used to form the pleats, including, for example, a pusher bar type corrugator, a blade type corrugator, a rotary type corrugator, or an in-line type corrugator. Various corrugation techniques are disclosed in U.S. Pat. No. 5,543,047. The plurality of pleats may then be arranged into a generally cylindrical fluid treatment pack. A spacer arrangement may be associated with some, most or all of the pleats in a variety of ways. For example, the spacer arrangement may be positioned within the pleats, e.g., between the legs of the pleats to space the legs apart, and define regions which are substantially free of structure. The ends of the fluid treatment pack may be sealed, e.g., completely or partially, to establish the tangential fluid flow path via the regions that are substantially free of structure and the lateral flow path through the fluid treatment medium. The spacer arrangement may be positioned within the pleats during or after corrugation; before, as, or after the pleats are arranged into the fluid treatment pack; and/or before, as, or after the ends of the fluid treatment pack are sealed.

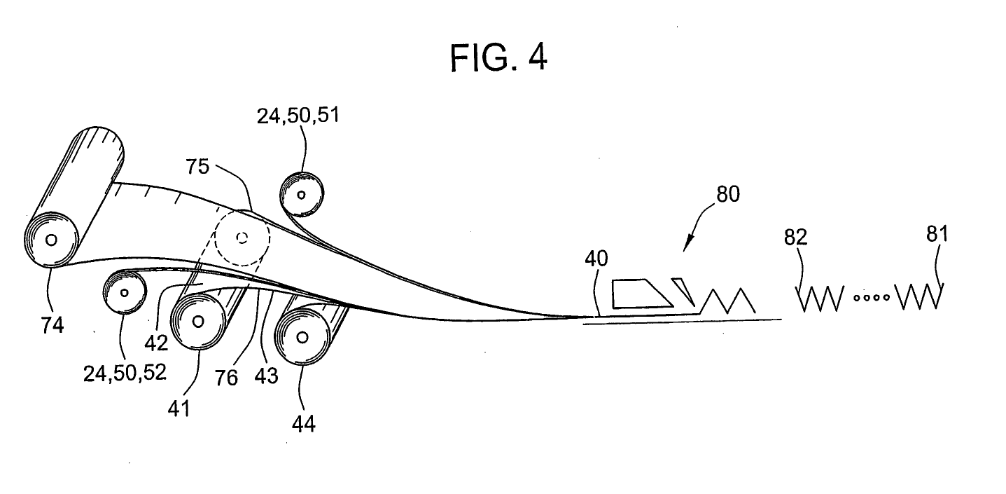

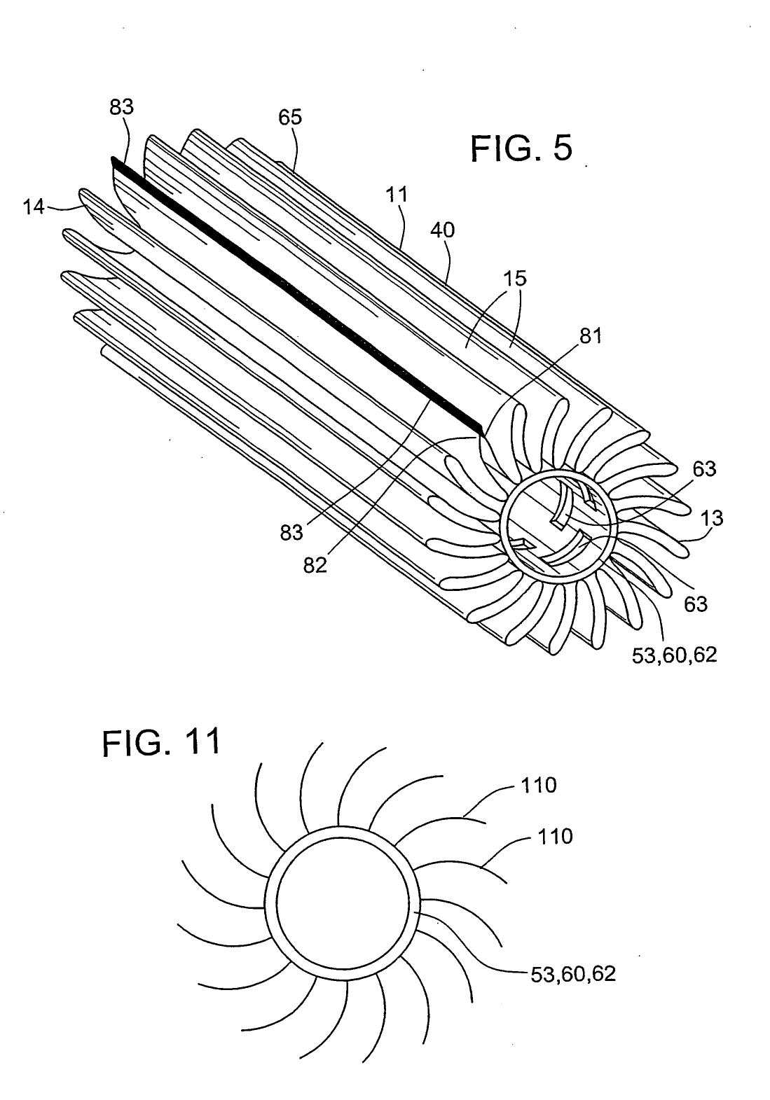

Another of many examples of a method of making a fluid treatment element 10 is represented in FIGS. 4 and 5. For example, a composite 40 may be formed from separate layers of a fluid treatment medium 41, a drainage medium, 44, a spacer arrangement 24, and a strip-out material 74, as shown in FIG. 4. The fluid treatment medium 41 may include opposite surfaces 42, 43 and opposite side edges 75, 76. The drainage medium 44 may be positioned along one surface of the fluid treatment medium 41, e.g., along the surface 43 which becomes the outer surface 43 of the fluid treatment medium 41 in a cylindrical fluid treatment pack.

The spacer arrangement 24 may also be positioned along one surface of the fluid treatment medium 41, e.g., along the surface 42 which becomes the inner surface 42 of the fluid treatment medium 41 in a cylindrical fluid treatment pack. The spacer arrangement may comprise only one spacer, e.g., one strip which may be positioned along one of the side edges of the fluid treatment medium. In the illustrated embodiment, the spacer arrangement 24 comprises two spacers, e.g., two strips 51,52 positioned along both side edges 75,76 of the fluid treatment medium 41. Positioning the spacer strips 51,52 along the side edges 75,76 allows the spacer arrangement 24 to be securely held in place when the sealing mechanism is joined to the ends of the fluid treatment pack 11. However, the sealing arrangement may comprise fewer or more than two spacer strips and may be positioned at different locations within the composite.

The strip-out material 74 may be positioned along the same surface 42 of the fluid treatment medium 41 as the spacer arrangement 24 and may at least partially occupy the regions not occupied by the spacer arrangement 24. For example, in the illustrated embodiment the strip-out material 74 comprises only one sheet of material that extends from one spacer strip 51 to the other spacer strip 52. Alternatively, the strip-out material may be narrower than the distance between the strips 51,52 and/or may comprise two or more sheets or strips. For many embodiments, the strip-out material may be similar to the materials described as drainage media in U.S. Pat. No. 5,543,047 and U.S. Pat. No. 5,252,207. The thickness of the strip-out material may be approximately equal to the thickness of the spacer arrangement 24. For some embodiments, the strip-out material may be omitted.

Additional layers, e.g., a cushioning medium, may be fed to the composite, and each of the layers may be fed form a source, such as a roll. All of the layers may come together to form the composite at the same time, e.g., at the corrugator. Alternatively, subcomposites of fewer than all of the layers may be formed at different times, and the subcomposites may subsequently be formed into the composite. The layers, subcomposites, and composites may undergo various processes, e.g., trimming, calendaring and/or heat-setting, prior to corrugation.

After the composite 40 is formed, it may be corrugated by any suitable corrugator. For example, the composite 40 may be fed into a pusher-bar type corrugator 80 as disclosed in U.S. Pat. No. 5,543,047. The corrugator 80 folds the composite 40 into a plurality of pleats 15 which extend in an axial direction. The heights of the pleats and/or the lengths of the legs 22,23 of the pleats 15 may vary, depending, for example, on the desired size and configuration of the fluid treatment pack 11. For each pleat 15 the legs 22,23 may have about equal lengths or one leg may be longer than the other leg. Further, the legs may be straight or curved. In addition to forming the pleats 15, the corrugator 80 may perform various other processes, including heat-setting and trimming. For example, after the composite 40 is pleated, a cutter (not shown) may cut the pleated composite axially, providing a leading edge 81, a trailing edge 82 and a predetermined number of pleats 15 for the fluid treatment pack 11.

Incorporating the spacer arrangement 24 in the composite 40 and folding the spacer strips 51,52 with the other layers of the composite 40 has many advantages. For example, it reduces the complexity of the manufacturing process because no additional steps are required to insert spacers between the pleats after the pleats are formed. Further, it ensures that every pleat has a spacer because the spacer strips are folded into each pleat, along with the other layers of the composite, as the pleat is being formed.

Incorporating the strip-out material 74 in the composite 40 along with the spacer arrangement 24 and folding strip-out material 74 with the other layers of the composite 40 also has many advantages. For example, it prevents undue compression of the spacer arrangement 24 as the composite 40 is pressed between the pleating surfaces of the corrugator 80. Further, because the strip-out material 74 is folded with the remainder of the composite 40, the radius at the inner surface of the folded end 20 of the pleat 15 may be larger than it would be if the strip-out material 74 were omitted during corrugation. This larger radius provides a more open and, therefore, a less restricted region 31 substantially free of structure within each pleat 15 after the strip-out material has been removed.

The strip-out material 74 may be removed from the pleated composite 40 at any suitable time. For example, after the pleats 15 have been formed by the corrugator 80 but before the predetermined number of pleats 15 have been cut from the pleated composite 40, the strip-out material 74 may be stripped from the pleated composite 40. Alternatively, the strip-out material 74 may be stripped from the pleated composite 40 after the predetermined number of pleats 15 have been cut. Once the strip-out material 74 has been removed, the regions 31 between the spacer strips 51,52 and between the legs 22,23 of the pleats 15 are substantially free of structure. As yet another alternative, the strip-out material 74 may remain with the pleated composite 40 as the fluid treatment pack 11 is being formed.

The pleated composite 40 may be arranged into a generally cylindrical fluid treatment pack 11 in a variety of ways. For example, the leading edge 81 and the trailing edge 82 of the pleated composite 40 may be brought around and positioned next to one another, as shown in FIG. 5, forming a hollow, generally cylindrical fluid treatment pack 11 having an interior 54, an exterior 65, and opposite ends 13,14. A side seal 83 may then be formed along the edges 81,82 in any number of ways, including, for example, melt bonding, adhesive bonding and/or mechanically connecting, e.g., crimping. If the strip-out material 74 is still part of the pleated composite 40, the strip-out material may be incorporated in the side seal 83. Alternatively, the strip-out material 74 may be trimmed back from the leading and trailing edges 81,82 prior to forming the side seal 83. After the side seal 83 is formed, the strip-out material 74 may be removed, for example, by stripping the strip-out material 74 from the fluid treatment pack 11, e.g., from the interior 54 of the fluid treatment pack 11. If the strip-out material 74 is incorporated in the side seal 83, it may be stripped from the composite 40 and then cut inwardly from the side seal 83 prior to removal. With the strip-out material 74 removed, the regions 31 between the spacer strips 51,52 and between the legs 22,23 of the pleats 15 are substantially free of structure, and the open ends 21 of the pleats 15 communicate between these regions 31 and the interior 54 of the fluid treatment pack 11.

Prior to sealing the ends 13,14 of the fluid treatment pack 11, the core arrangement 53 and the surround 64 may be fitted to the fluid treatment pack 11. The core arrangement 53 may be inserted within the interior 54 of the fluid treatment pack 11. The open inner ends 21 of the pleats 15 may be blinded by the blind portion 55 of the core arrangement 53 but may communicate with the end portions 60 of the core arrangement 53 beyond the barriers 61 via the perforated or porous side wall 62. The surround 64 may be fitted around the exterior 65 of the fluid treatment pack 11. The surround 64 may, or may not, be bonded to the folded ends 20 of the pleats 15. The pleats 15 may be arranged to extend in a generally radial direction, in a straight non-radial direction, or in an angled or curved non-radial direction from the open ends 21 at the core arrangement 24 to the folded ends 20 at the surround 64. For pleats that extend generally radially, the pleats may have a height approximately equal to (D-d)/2 and for pleats that extend non radially, the pleats may have a height greater than (D-d)/2, where D and d are the outer and inner diameters, respectively, of the fluid treatment pack 11. For some embodiments, the pleats 15 may be arranged between the core arrangement 53 and the surround 64 with all of the pleat heights being the same. For other embodiments, the pleat heights within the fluid treatment pack may differ from one to another.

The ends 13,14 of the fluid treatment pack 11 may then be sealed, for example, by applying a sealant or by attaching end caps 70,71 to the ends 13,14. The end caps 70,71 may be attached to the ends 13,14 of the fluid treatment pack 11, as well as the ends of the core arrangement 53 and/or the surround 64, in a variety of ways. For example, the end caps 70,71 may be melt-bonded or adhesively bonded to the ends of the fluid treatment pack 11, the core arrangement 53, and the surround 64. Bonding the spacer arrangement 24, e.g., the spacer strips 51,52, to the end caps 70,71 along with the other layers of the composite 40 may fixedly secure the spacer arrangement 24 as well as the other layers of the composite 40, in place. Once the ends 13,14 of the fluid treatment pack 11 are sealed, e.g., by attaching the end caps 70,71, the tangential fluid flow path 32 and the lateral fluid flow path 34 through the fluid treatment element 10 are established.

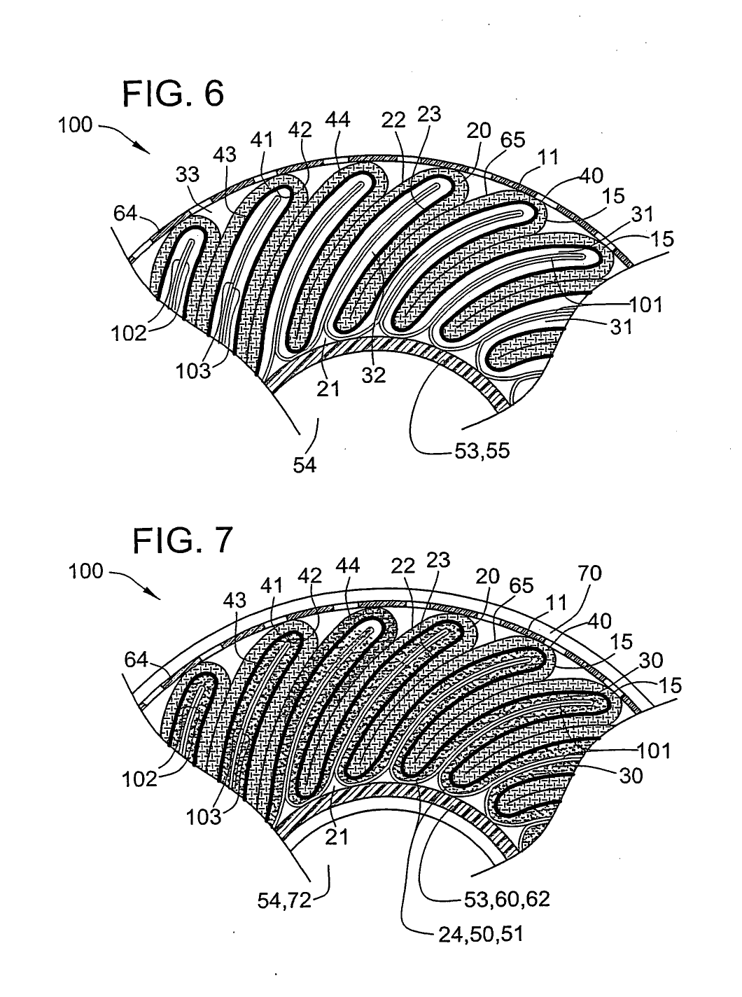

Another example of a fluid treatment element 100 embodying the invention is shown in FIGS. 6 and 7. The fluid treatment element 100 shown in FIGS. 6 and 7 has many features which are similar to those described and suggested for the fluid treatment element 10 shown in FIGS. 1-3, and corresponding components are identified with the same reference numbers. For example, both the fluid treatment element 100 shown in FIGS. 6 and 7 and the fluid treatment element 10 shown in FIGS. 1-3 may include a fluid treatment pack 11 having an axis 12, opposite ends 13,14, a fluid treatment medium 41, and a plurality of axially extending pleats 15. Each pleat 15 includes a folded end, e.g., a folded outer end 20, an open end, e.g., an open inner end 21, and two legs 22,23 which extend between the folded end 20 and the open end 21. The ends of the fluid treatment pack 11 are sealed by a sealing mechanism, such as pair of open end caps 70,71. A core arrangement 53 having a blind portion 55 and opposite end portions 60 and/or a surround 64 may be associated with the interior and the exterior of the fluid treatment pack 11. Both fluid treatment elements 10,100 include a tangential fluid flow path 32 that extends generally axially along the pleats 15 and a lateral fluid flow path 33 that fluidly communicates with the tangential fluid flow path 32 and extends laterally through the fluid treatment medium 41.

Further, in both the fluid treatment element 100 shown in FIGS. 6 and 7 and the fluid treatment element 10 shown in FIGS. 1-3, the fluid treatment pack 11 may comprise a multilayer composite 40 which includes a fluid treatment medium 41 having an inner surface 42 and an outer surface 43. A drainage medium 44 may be positioned along the outer surface 43 of the fluid treatment medium 41. Other porous media, such as a cushioning layer (not shown), may also be positioned along the outer surface 43 of the fluid treatment medium 41.

The fluid treatment medium 100 shown in FIGS. 6 and 7 may include one or more additional porous media. For example, one or more porous media 101 may be positioned along the inner surface 42 of the fluid treatment medium 41. A spacer arrangement 24 may be associated with the pleats 15 to define a region 31 substantially free of structure between the porous medium 101 and the surface 42 of the fluid treatment medium 41. While the porous medium may comprise any of a wide variety of woven, nonwoven, or mesh sheets, the porous medium 101 for many embodiments may comprise a drainage medium. For example, a drainage medium may comprise a mesh layer, including an extruded mesh layer having one set of parallel strands fixed atop another set of parallel strands, e.g., a machine direction set of strands fixed atop a cross direction set of strands. Either set of strands, or neither set of strands, may be situated in the multilayer composite 40 with the strands running generally axially, parallel to the pleats 15.

The spacer arrangement may be configured in a variety of ways, as previously described with respect to the fluid treatment element 10 shown in FIGS. 1-3. In the fluid treatment element 100 shown in FIGS. 6 and 7, the spacer arrangement 24 may comprise one or more spacers 50 as one or more layers of the multilayer composite 40. For example, the spacers 50 may comprise two spacer strips 51,52 which are incorporated in, and corrugated with, the composite 40 at the first and second ends of the fluid treatment pack 11.

The spacer arrangement may be positioned at a variety of locations to define a region substantially free of structure within the legs of the pleats and between the porous medium and the surface of the fluid treatment medium. For example, the spacer arrangement may be positioned in the multilayer composite to locate the region substantially free of structure directly next to, i.e., adjoining, the surface of the fluid treatment medium. In the fluid treatment element 100 shown in FIGS. 6 and 7, the spacers 50, e.g., the spacer strips 51,52, adjoin the inner surface 42 of the fluid treatment medium 41 on one side and the outer surface 102 of the porous medium 101, e.g., the drainage medium on the other side. The spacer arrangement 24 thus defines a region 30 within the legs 22,23 of each pleat 15 which is occupied by the spacer arrangement 24 and a region 31 within the legs 22,23 of each pleat 15 which is substantially free of structure and which adjoins the inner surface 42 of the fluid treatment medium 41 and the outer surface 102 of the porous drainage medium 101.

The thickness of the spacer arrangement 24, which generally corresponds to the thickness of the region 31 substantially free of structure, and the thickness of the porous medium 101 may be selected in accordance with several factors, including the desired number of pleats and the desired size of the region substantially free of structure. For many embodiments the combined thicknesses may be in the range from about 0.05 mm or less to about 5 mm or more, or in the range from about 0.1 mm to about 2.0 mm, or in the range from about 0.1 mm to about 1.0 mm. The thickness of the spacer arrangement 24 may be greater than the thickness of the porous medium 101, thereby increasing the size of the region 31 substantially free of structure. For example, the thickness of the spacer arrangement 24 may be at least about 1.1 or about 1.2 or about 1.5 or about 2 or about 2.5 or about 3 or about 4 or about 5 or more times the thickness of the porous medium 101. For some embodiments, the thickness of the porous medium 101 may be about 0.2 mm and the thickness of the spacer arrangement maybe about 0.4 mm. For many embodiments, the thickness of the porous medium 101 along the inner surface 42 of the fluid treatment medium 41 may be less than the thickness of the drainage medium 44 along the outer surface 43 of the fluid treatment medium 41.

In the fluid treatment element 100 shown in FIGS. 6 and 7, the fluid treatment pack 11 may have only one porous medium 101 extending along the inner surface 42 of the fluid treatment medium 41, and the spacer arrangement 24 may be positioned between the fluid treatment medium 41 and the porous medium 101, with the region 31 substantially free of structure adjoining the inner surface 42 of the fluid treatment medium 41. However other embodiments may include more than one porous medium extending along the surface of the fluid treatment medium and/or a spacer arrangement which may be a differently positioned. For example, in addition to the drainage medium, a support medium and/or a cushioning layer may extend along the inner surface of the fluid treatment medium between the fluid treatment medium and the drainage medium. The spacer arrangement, as well as the region substantially free of structure, may then be positioned between the inner surface of the fluid treatment medium and the cushioning layer, or between the cushioning layer, or the support medium, and the drainage medium.

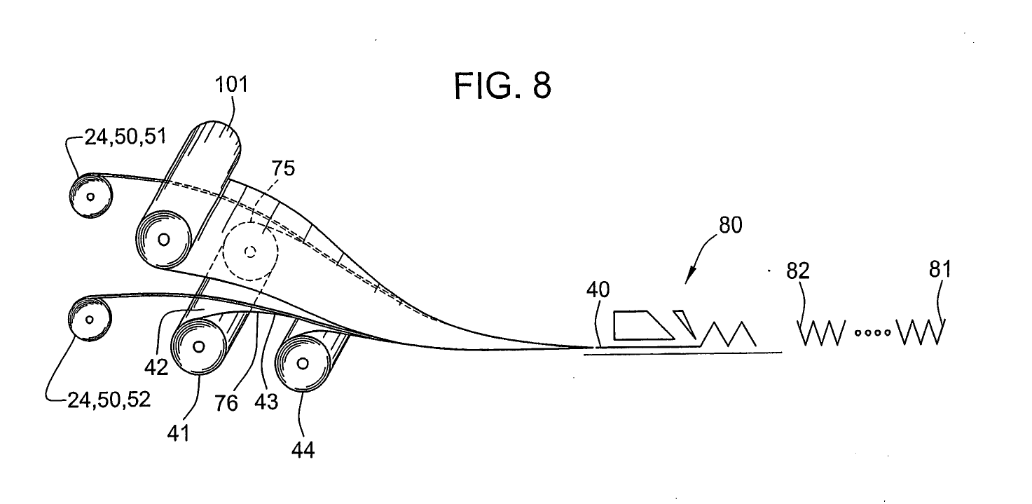

Fluid treatment elements similar to the fluid treatment element 100 shown in FIGS. 6 and 7 may be made in any of several different ways, including many of the ways described with respect to the fluid treatment element 10 shown in FIGS. 1-3. For example, a multilayer composite 40 may be formed from separate layers of fluid treatment medium 41, two drainage media 44, 101, and a spacer arrangement 24, as shown in FIG. 8. The outer drainage medium 44 may be positioned along the surface 43 of the fluid treatment medium 41 that becomes the outer surface 43, and the inner drainage medium 101 may be positioned along the surface 42 of the fluid treatment medium 41 that becomes the inner surface 42. The spacer arrangement 24, for example, two spacer strips 51,52, may be positioned between the inner surface 42 of the fluid treatment medium 41 and the inner drainage medium 101, for example, along the side edges 75, 76 of the fluid treatment medium 41. For example, the spacer strips 51, 52 may be positioned in contact with the inner surface 42 of the fluid treatment medium 41 and/or the outer surface 102 of the inner drainage medium 101.

After the multilayer composite 40 is formed, it may be corrugated and arranged into a generally cylindrical fluid treatment pack 11 in a manner similar to that described and suggested with respect to the embodiments shown in FIGS. 4 and 5, except the embodiment shown in FIG. 8 may have no strip-out material. As shown in FIG. 6, the fluid treatment pack 11 may have a region 31 substantially free of structure within each pleat 15, e.g., within each leg 22, 23 of each pleat 15. The spacer arrangement 24 and the region 31 substantially free of structure may be positioned between the inner surface 42 of the fluid treatment medium 41 and the outer surface 102 of the inner drainage medium 101, for example, adjoining the inner surface 42 of the fluid treatment medium 41 and the outer surface 102 of the inner drainage medium 101. The inner surface 103 of the inner drainage medium 101 of one leg may face or even contact the inner surface 103 of the inner drainage medium 101 of an adjacent leg.

The fluid treatment pack 11 may be fashioned into a fluid treatment element 100 by the addition of sealing mechanisms, e.g., open end caps 70,71, a core arrangement 53, and/or a surround 64 as previously described with respect to the fluid treatment element 10 shown in FIGS. 1-3.

Fluid treatment elements embodying the invention may be contained within a wide variety of housings to form a fluid treatment assembly. For example, a housing may be formed from any impermeable material, e.g., a metallic material or a polymeric material, which is chemically compatible with the fluids and mechanically capable of withstanding the process parameters, e.g., pressure and temperature. The fluid treatment element may be permanently contained within the housing, forming a disposable fluid treatment assembly, or it may be removably contained within the housing, allowing a used fluid treatment element to be replaced by a new fluid treatment element within a reusable housing.

Fluid treatment assemblies may be configured in many different ways. For example, a fluid treatment assembly may comprise a housing containing only a single fluid treatment element or a housing containing multiple fluid treatment elements arranged serially or in parallel within the housing. The fluid treatment assembly may have three or more principal ports. For example, where the fluid treatment assembly serves a separator such as a filter, it may include a feed or process fluid port, a concentrate or retentate port, and a filtrate or permeate port. Where the fluid treatment assembly serves as a mass transfer device for transferring a substance from one fluid to another, it may include an inlet port and an outlet port for each fluid. The fluid treatment assembly may further include various supplemental ports, e.g., ports associated with venting or backwashing.

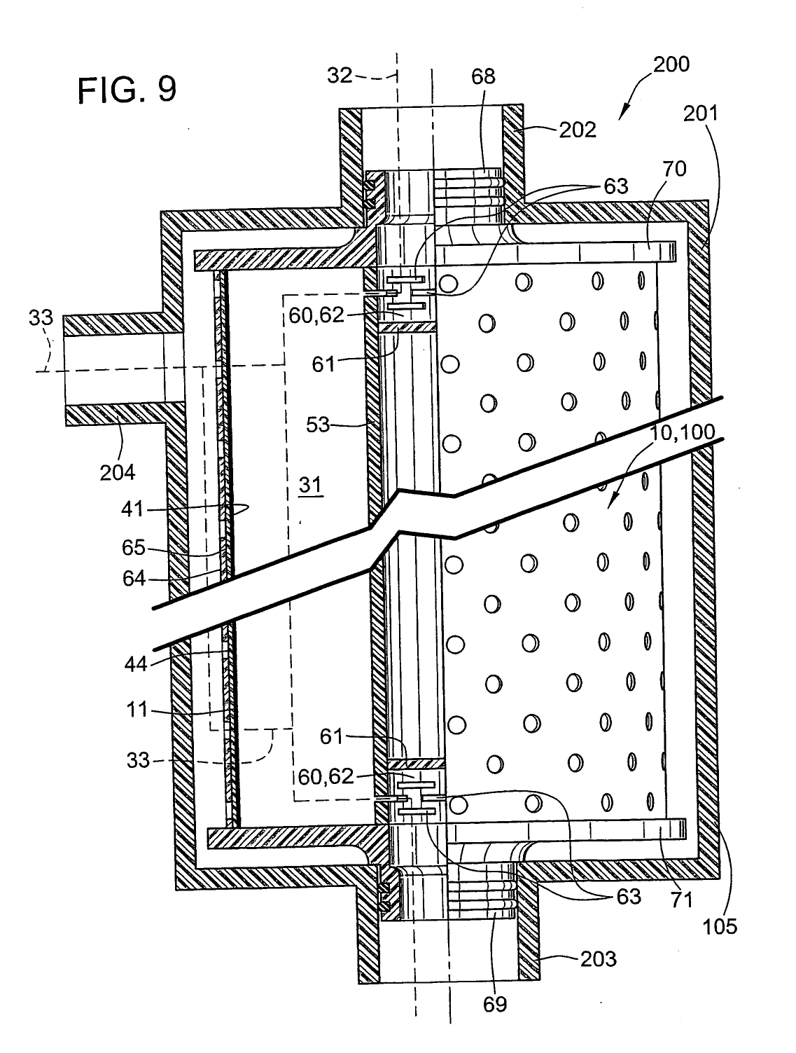

One of many different examples of a fluid treatment assembly 200 is shown in FIG. 9. The fluid treatment assembly 200 includes a housing 201 which may permanently contain a fluid treatment element, such as a fluid treatment element 10,100 similar to those previously described and suggested. The fluid treatment assembly 200 may serve as a filtration module and may include a feed or process fluid port 202 coupled to the feed fluid inlet fitting 68 of the fluid treatment element 10,100, a concentrate or retentate port 203 coupled to the concentrate outlet fitting 69 of the fluid treatment element 10,100, and a filtrate or permeate port 204 which fluidly communicates with the exterior 65 of the fluid treatment pack 11. The fluid treatment element 10,100 is sealed within the housing 201 to isolate the feed port 202 and the concentrate port 203 from the permeate 204.

Fluid treatment elements and assemblies embodying the invention may be used to treat any of a myriad of fluids in any of numerous crossflow processes. In one of many applications, a fluid treatment element and assembly may be used to treat cellular solutions, e.g., liquid solutions containing cells and/or cellular components. Cellular solutions may contain any of a wide variety of cells, including bacterial cells, fungal cells, yeast cells, and mammalian cells, especially Chinese Hamster Ovary (CHO) cells. Cellular solutions may contain a wide variety of cellular components, including cellular products such as proteins and enzymes, cellular structures, and substances to be incorporated into cells. Cellular solutions may be treated in numerous ways. For example, cellular solutions may be processed to harvest, separate, concentrate, and/or purify the cells and/or cellular components. Cellular solutions can be somewhat viscous and very sensitive, the cells and/or cellular components of the solution being easily damaged. Fluid treatment elements embodying the invention are particularly well suited for processing liquid cellular solutions.

A feed fluid, such as a cellular solution including a suspending liquid and one or more types of cells and/or cellular components, may be directed axially along the fluid treatment element 10 within the pleats via the tangential fluid flow path 32, as shown in FIG. 9. For example, the cellular solution may be directed through the feed port 202 of the fluid treatment assembly 200 and generally axially into the feed inlet 68 and the end portion 60 of the core arrangement 53 of the fluid treatment element 10,100. The barrier 61 then directs the cellular solution generally radially outwardly through the openings 63 in the perforated side wall 62 of the end portion 60 and the open inner ends of the pleats.

The feed fluid, e.g., the cellular solution, then passes axially along the tangential fluid flow path 32 between or within the legs of the pleats from one end of the element 10,100 to the opposite end. In the fluid treatment element 10 shown in FIGS. 1-3, the fluid may flow along this portion of tangential fluid flow path 32 solely through the regions 31 that are substantially free of structure. In the fluid treatment element 100 shown in FIGS. 6 and 7, the fluid may flow along this portion of the tangential fluid flow path 32 through both the regions 31 that are substantially free of structure and the inner porous medium, e.g., the drainage medium 101. Most of the fluid may flow through the regions 31 substantially free of structure because these regions 31 may be larger and have less flow resistance than the inner porous medium 101.

For many embodiments, the feed fluid, e.g., the cellular solution, may be initially directed into and along the regions 31 substantially free of structure at a lower pressure and/or flow rate, and the pressure and/or flow rate of the feed fluid may then be increased to the normal operating pressure and/or flow rate over a period of time. For example, the cellular solution may be initially directed into and along the regions 31 substantially free of structure at a pressure which provides a flow rate of about 0.5 to about 1 liter/minute. The pressure of the cellular solution may then be increased over a period of about 3 to about 5 minutes to provide a normal operating flow rate of about 7 liters/minute. For many embodiments, the transmembrane pressure along most or all of the fluid treatment medium during normal operation may be arranged to be positive, and the transmembrane pressure at the retentate end of the fluid treatment element is preferably no less than about negative 0.5 psi.

Within the tangential fluid flow path 32 along the fluid treatment medium 41, the feed fluid, e.g., the cellular solution, may be treated in any of a variety of ways. For example, the cellular solution may be treated, for example, by removing some of the suspending liquid and/or one or more other substances in the cellular solution via the lateral fluid flow path 33 through the fluid treatment medium 41 of the fluid treatment pack 11. The fluid treatment element 10,100 may thus serve as a concentrator, for example, principally allowing the suspending liquid to pass as permeate generally radially outwardly through the fluid treatment medium 41 via the lateral fluid flow path 33 to the exterior 65 of the fluid treatment pack 11 and, hence, to the permeate port 204 of the fluid treatment assembly 200. Alternatively or additionally, the fluid treatment element 10,100 may serve as a separator, for example, allowing one or more substances, such as proteins or enzymes, to bind to the fluid treatment medium 41 or to pass as permeate generally radially outwardly through the fluid treatment medium 41 via the lateral fluid flow path 33 to the permeate port 204. Alternatively, the cellular solution may be treated by adding one or more substances to the cellular solution radially inwardly through the fluid treatment medium 41 via the lateral fluid flow path 33.

Fluids and substances in the fluids pass to or from the tangential fluid flow path 32 through the fluid treatment medium 41 via the lateral fluid flow path 33. Many embodiments of the fluid treatment element 10,100 may include a surround 64 which may have openings such as open pores or perforations along most or all of its length. The fluids and substances in the fluids may then pass via a lateral fluid flow path 33 which extends through the fluid treatment medium 41 and any other downstream layers of the fluid treatment pack 11 and generally radially through the openings in the surround 64.

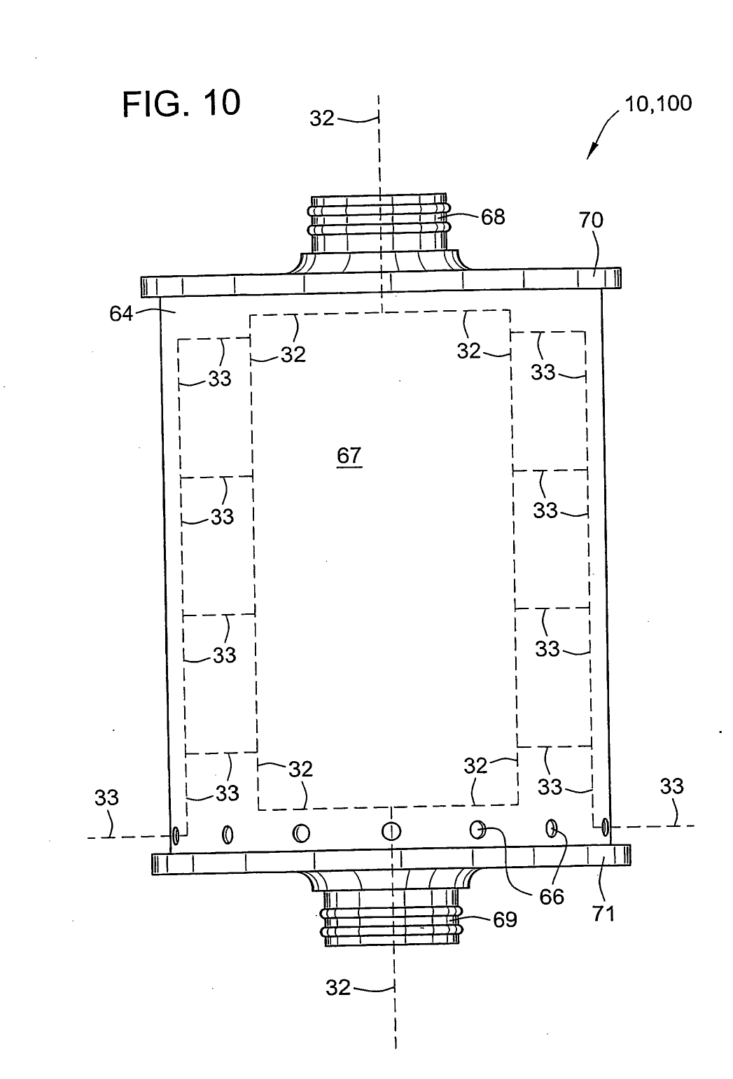

Other embodiments of the fluid treatment 10,100 may include a surround 64 which may have openings only along a specific region of the surround 64, e.g., only at one or both ends of the fluid treatment element 10,100. For example, as shown in FIG. 10, the surround 64 may have openings 66 only at one end of the fluid treatment element 10,100. In the illustrated embodiment, the openings, e.g., perforations 66, may be only at the end near the retentate outlet opening 69. The surround 64 may be variously configured. For example, the surround 64 may comprise a flexible, impermeable sleeve or wrap having a blind portion 67 along most of its length and openings 66 only at one end, e.g., the retentate end. Alternatively, the surround 64 may comprise a more rigid, impermeable cage or tube having a blind portion 67 along most of its length and openings 66 only at one end, e.g., the retentate end. As yet another alternative, the surround may comprise a cylindrical side wall of a housing which may be fitted against the exterior of the fluid treatment pack. The housing may then have a port communicating with a channel, e.g., an annular channel, at one end, e.g., the retentate end, of the fluid treatment pack.

The fluids and the substances in the fluids, e.g., the permeate, may pass via a lateral fluid flow path 33 which extends through the fluid treatment medium along the entire height of the fluid treatment element 10,100. Away from the openings 66, the lateral fluid flow path 33 further extends axially or tangentially between the outer or downstream side of the fluid treatment medium and the inner surface of the surround 64 to the openings 66 and then generally radially through the openings 66. The fluids and the substances in the fluids may flow toward the openings 66 axially within the pleats, e.g., along the downstream drainage layer, or axially between the folded outer ends of the pleats and the inner surface of the surround 64. The surround 64 may have structures such as ribs or lands along the inner surface of the surround which define passageways leading to the openings 66. By providing the openings 66 in the surround 64 at the retentate end of the fluid treatment element 10,100, the fluid and the substances in the fluid flowing outwardly through the fluid treatment medium 41 along the lateral fluid flow path 33 may flow in the same direction, or co-currently, as the direction that the feed fluid flows along the tangential fluid flow path 32. Alternatively, the openings may be located at the inlet end of the fluid treatment element, and the fluid and the substances in the fluid flowing outwardly through the fluid treatment medium along the lateral fluid flow path may flow in the direction opposite, or counter-currently, to the direction that the feed fluid flows along the tangential fluid flow path.

As shown in FIG. 9, at the end of the fluid treatment element 10,100 opposite the feed inlet 68, the remaining feed fluid, e.g., the remaining cellular solution, then passes generally radially inwardly along the tangential fluid flow path 32 from the open inner ends of the pleats and the perforated side wall 62 into the end portion 60 of the core arrangement 53. The barrier 61 then directs the cellular solution generally axially along the tangential fluid flow path 32 from the end portion 60 of the core arrangement 53 through the concentrate outlet 69 of the fluid treatment element 10 and out through the concentrate port 203 of the fluid treatment assembly 200. In a single pass mode of operation, the cellular solution may be directed from the concentrate port 203 of the fluid treatment assembly 200 to other components of the fluid system (not shown). In a multipass mode or a recirculating mode of operation, the cellular solution may be directed back to the feed port 202 of the fluid treatment assembly 200 for continued treatment within the fluid treatment element 10,100.

Many advantages are associated with fluid treatment elements embodying one or more aspects of the invention. For example, by providing a tangential fluid flow path 32 through regions 31 which are substantially free of structure, fluid treatment elements embodying the invention offer less resistance to the flow of fluids, such as the cellular solution. The fluids may thus flow through the fluid treatment element with a smaller pressure drop. Further, because at least 50%, or at least 70%, or at least 80%, or at least 90%, or at least 95% of the tangential fluid flow path 32 through the fluid treatment element may be through regions 31 which are substantially free of structure, fluids, such as the cellular solution, may flow through the fluid treatment element with little or no damage, for example, to the cells and/or cellular components in the solution. Fluid treatment elements embodying the invention may thus reduce the need for additional downstream processing to remove cellular debris and prevent the release of dangerous endotoxins into the retentate or the permeate. In addition, by locating the regions substantially free of structure directly next to the surface of the fluid treatment medium, fluid flowing along the tangential flow path can more thoroughly clear foulants form the surface of the fluid treatment medium. This can extend the service life of the fluid treatment element.

Fluid treatment elements having a region substantially free of structure and an adjacent porous medium, including elements similar to those disclosed in FIGS. 6 and 7, have additional advantages. For example, by providing both a region substantially free of structure and a porous medium, e.g., a drainage medium, in the tangential fluid flow path along the fluid treatment medium, the fluid treatment element can operate more effectively. During many normal modes of operation, the fluid in the tangential flow path in the regions substantially free of structure is generally at a higher pressure than the fluid on the opposite side of the fluid treatment medium, and the regions substantially free of structure remain open to fluid flow. However, there may be instances when the fluid pressure along all or some portion of the regions substantially free of structure is less than the fluid pressure on the opposite side of the fluid treatment medium. Adjacent pleat legs may then expand toward one another, collapsing some portion or all of the region substantially free of structure within each pleat. However, when the normal mode of operation is resumed, the regions substantially free of structure can be immediately reestablished. The higher pressure fluid easily flows along the tangential flow path within each pleat via the porous medium, e.g., the drainage medium, where it forces the adjacent legs of each pleat back to their normal position, quickly reestablishing the regions substantially free of structure within each pleat.

Fluid treatment elements having a surround with openings only in a specific region, including elements similar to those disclosed in FIG. 10, also have additional advantages. By directing fluid and substances in the fluid along a substantial portion of the lateral fluid flow path co-currently or counter-currently with the feed fluid along the tangential fluid flow path, various operating parameters, such as transmembrane pressure or flux, may be enhanced. This can lead to improved efficiency or longer service life.

Some of the benefits of fluid treatment elements embodying various aspects of the invention are illustrated in the following Examples.

### EXAMPLE 1

This example demonstrates an effect of directing a cellular solution through a pleated, crossflow fluid treatment element without regions substantially free of structure.

The crossflow fluid treatment element is similar to the element 10 shown in FIGS. 1-3, except the crossflow fluid treatment the element has no spacer arrangement 24 and no regions 31 which are substantially free of structure. In place of the spacer arrangement and the regions substantially free of structure is an inner net drainage medium comprising a symmetrical polypropylene extruded net having a thickness of 0.33 mm and a strand count of 31 strands per inch in both directions. The pleated fluid treatment pack consists of the inner net drainage medium, a fluid treatment medium comprising a PES membrane having a removal rating of 0.65 microns, and an outer drainage medium comprising a spunbonded polypropylene nonwoven material having a thickness of 0.3 mm. The pleats extend from the core arrangement to the surround in a curved direction. The outer diameter of the core arrangement is 46 mm, the inner diameter of the surround is 66.5 mm and the crossflow fluid treatment element is 24.5 cm long.

The cellular solution includes an aqueous-based liquid culture medium containing mammalian CHO cells.

The cellular solution is recirculated through the crossflow fluid treatment element from the feed inlet through the inner net drainage medium to the concentrate outlet at a crossflow rate of 10 L/minute for 155 minutes. The permeate port is closed for the first 145 minutes and open for the last 10 minutes.

The initial concentration is 5.6×10⁵ cells/ml of the cellular solution and the initial viability is 96%.

The final concentration is 1.5×10⁴ cells/ml of cellular solution and the final viability is unmeasurable due to low cell count.

Cell debris is observed in the permeate fluid.

### EXAMPLE 2

This example demonstrates an effect of directing a feed fluid such as a cellular solution through a pleated, crossflow fluid treatment element embodying an aspect of the invention.

The crossflow fluid treatment element is similar to the element 10 shown in FIGS. 1-3 and includes spacer strips at each end of the pleated fluid treatment pack and regions between the strips that are substantially free of structure. The pleated fluid treatment pack consists of two layers of a fluid treatment medium, each comprising a PES membrane having a removal rating of 0.65 microns, and an outer drainage medium comprising a spunbonded polypropylene nonwoven material having a thickness of 0.30 mm. The spacer strips consist of two strips of a spunbonded polypropylene nonwoven material having a width of 10 mm and a thickness of 0.30 mm. The spacer strips are pleated with the fluid treatment pack, one at each end of the pack. The pleats extend from the core arrangement to the surround in a curved direction. The number of pleats, the outer diameter of the core arrangement, the inner diameter of the surround, and the length of the element are substantially the same as in Example 1.

The cellular solution is an aqueous-based liquid culture medium containing mammalian CHO cells.

The cellular solution is recirculated through the crossflow fluid treatment element from the feed inlet through the regions substantially free of structure to the concentrate outlet at a crossflow rate of 7 L/minute for 177 minutes. The permeate port is open for the entire 177 minutes.

The initial concentration is 7.7×10⁴ cells/ml of cellular solution and the initial viability is 63%.

The final concentration is 2.13×10⁵ cells/ml of cellular solution and the final viability is 72%.

No cellular debris is observed in the permeate fluid.

### EXAMPLE 3

This example demonstrates an effect of directing a feed fluid such as a cellular solution through a pleated, crossflow fluid treatment element embodying an aspect of the invention.

The crossflow fluid treatment element is similar to the element 100 shown in FIGS. 6 and 7 and includes an inner porous medium, spacer strips at each end of the fluid treatment pack between the inner porous medium and the fluid treatment medium, and regions between the strips that are substantially free of structure. The pleated fluid treatment pack 11 consists of (1) an inner porous drainage medium comprising a 0.125 mm thick extruded polypropylene mesh having 41 strands per inch (25.4 mm) in the machine direction and 23 strands per inch (25.4 mm) in the cross direction; (2) a fluid treatment medium comprising two layers of a PES membrane having a removal rating of 0.65 micron; (3) two spacer strips comprising a spunbonded polypropylene nonwoven material having a thickness of 0.3 mm and being respectively positioned at each end of the pack between the inner porous medium and the fluid treatment medium; and (4) an outer drainage material comprising a spunbonded polypropylene nonwoven material having a thickness of 0.3 mm. There are 95 pleats, each pleat having a height of about 13 mm, and the pleats extend from the core arrangement to the surround in a curved direction. The outer diameter of the core arrangement is about 46 mm, the inner diameter of the surround is about 66.5 mm, and the length of the crossflow fluid treatment element is about 24.5 cm.

The cellular solution includes an aqueous-based liquid culture medium containing mammalian CHO cells.

The cellular solution is recirculated through the crossflow fluid treatment element from the feed inlet through the regions substantially free of structure and the inner porous medium to the concentrate outlet at a crossflow rate of 7 L/minute for 15 minutes. A peristaltic pump controls the permeate flow to a set rate of 1.7 L/minute. The flux rate is approximately 200 LMH.

The initial concentration is 9.1×10⁵ cells/ml of cellular solution and the initial viability is 98%.

The final concentration is 1.1×10⁷ cells/ml of cellular solution and the final viability is 97%.

No cell debris is observed in the permeate fluid.

While various aspects of the invention have previously been described and/or illustrated in the Figures, the invention is not limited to these embodiments. For instance, one or more of the features of these embodiments may be eliminated without departing from the scope of the invention. For example, as previously described, the core arrangement 53 or the strip-out material 74 may be omitted from some embodiments. As another example, the surround 64 may be omitted from some embodiments.

Further, one or more features of one or more embodiments may be combined with one or more features of other embodiments without departing from the scope of the invention. For example, in some embodiments an end cap 70 as shown in FIG. 1 at one end of the fluid treatment pack may be combined with a sealant as previously described at the other end of the fluid treatment pack. The core arrangement may then include an end portion having openings and a barrier only at the end of the fluid treatment element near the end cap.

Further, one or more features of the embodiments may be modified without departing from the scope of the invention. For example, the spacer arrangement may be associated with the core arrangement or one or both end caps rather than being incorporated in the composite. As shown in FIG. 11, the spacer arrangement 24 may comprise a plurality of spacer fins 110 which extend outwardly in a straight or curved direction from the core arrangement 53. Spacer fins 110 extending from the ends of the core arrangement 53 may be solid, porous, perforated, or channeled. Each spacer fin may have a thickness, width and height similar to spacers previously described. These spacer fins 110 may be arranged between the legs 22, 23 of the pleats 15 as the core arrangement 53 is inserted in the fluid treatment pack, replacing the spacer strips 51,52 of FIGS. 3 and 4. As the end caps are attached to the ends of the fluid treatment pack, the spacer fins 110 may also be attached to the end caps. While the illustrated spacer fins 110 project outwardly from the ends of the core arrangement 53, spacer fins may also, or instead, project from the core arrangement at locations intermediate the ends. The intermediate spacer fins may be porous, perforated or channeled to allow feed fluid to flow past the spacer fins and axially along the regions which are substantially free of structure. As yet another modification, the spacer fins may project inwardly from an end cap, for example, between layers of a multilayer composite, rather than outwardly from the core arrangement.

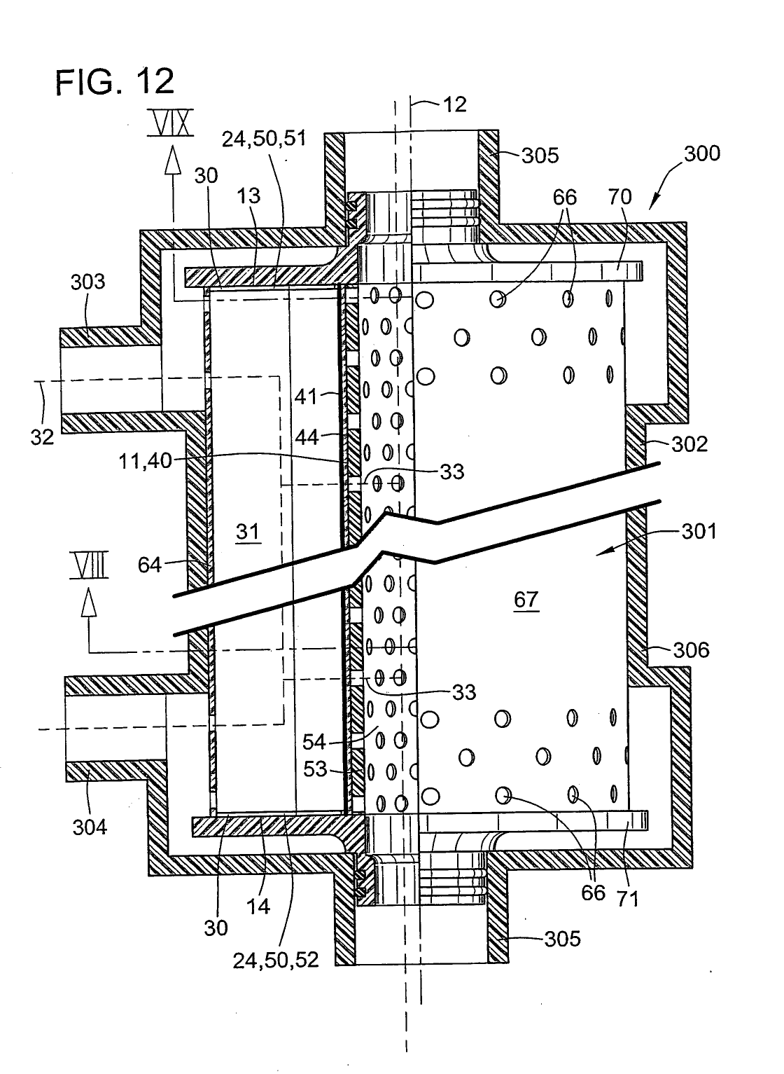

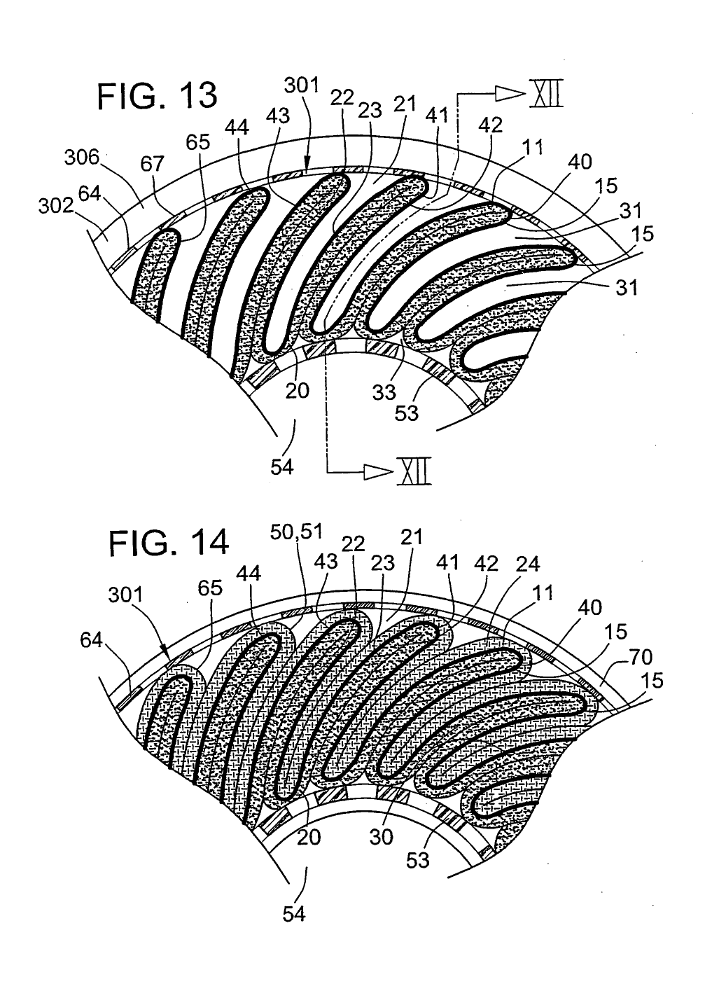

Further, embodiments having different features can still be within the scope of the invention. For example, fluid treatment assemblies and fluid treatment elements may have a tangential fluid flow path which extends within the pleats along the outer surface of the fluid treatment medium rather than the inner surface. One example of such a fluid treatment assembly 300 and a fluid treatment element 301 is shown in FIGS. 12-14. The features of the fluid treatment element 301 shown in FIGS. 12-14, including the components and the methods of making and using the element, may be analogous to those of the fluid treatment element 10 shown in FIGS. 1-3, and corresponding components may be identified with the same reference numerals. However, the geometry of the fluid treatment pack 11 of the fluid treatment element 301 may generally be reversed with respect to the geometry of the fluid treatment pack 11 of the fluid treatment element 10 shown in FIGS. 1-3. For example, the drainage medium 44 may be positioned along the inner surface 42 of the fluid treatment medium 41, while the spacer arrangement 24, e.g., the spacers 50 such as the spacer strips 51,52, and the regions 31 substantially free of structure may be positioned along the outer surface 43 of the fluid treatment medium 41.

For example, as shown in FIGS. 12-14, a fluid treatment element 301 may include a fluid treatment pack 11 having an axis 12, opposite ends 13, 14, a fluid treatment medium 41, and a plurality of axially extending pleats 15. Each pleat 15 includes a folded end, e.g., a folded inner end 20, an open end, e.g., an open outer end 21, and two legs which extend between the folded end 20 and the open end 21. The fluid treatment medium 41 may have an inner surface 42 and an outer surface 43, and the fluid treatment pack 11 may comprise a multilayer composite 40 having two or more layers. For example, an inner drainage layer 44 may extend along the inner surface 43 of the fluid treatment medium 41, either adjoining or spaced from the inner surface 43. Other porous media, such as a cushioning layer (not shown), may also be positioned along the inner surface 43 of the fluid treatment medium 41.

The spacer arrangement may be configured and positioned in the fluid treatment pack 11 in a variety of ways, as previously described with respect to the fluid treatment element 10 shown in FIGS. 1-3. In the fluid treatment element 301 shown in FIGS. 12-14, the spacer arrangement 24 may comprise one or more spacers 50,.e.g., two spacer strips 50,51, which are incorporated in, and corrugated with, the composite 40 along the outer surface 42 of the fluid treatment medium 41. The spacer arrangement defines one or more regions 30 that are occupied by the spacer arrangement 24 and one or more regions 31 that are substantially free of structure along the outer surface 43 of the fluid treatment medium 41. The spacer arrangement, the regions occupied by the spacer arrangement, and the regions substantially free of structure may adjoin the outer surface of the fluid treatment medium or may be spaced from the outer surface with one or more layers between them. The fluid treatment pack 11 may be positioned between a core arrangement 53 along the interior of the fluid treatment pack 11 and a surround 64 along the exterior 65 of the fluid treatment pack 11.

The surround 64, which may be analogous to the surround 64 shown in FIG. 10, may comprise a blind portion, e.g., a central blind portion 67, which serves to block off the open outer ends 21 of the pleats 15 and/or resist radially outward flow from the regions 31 that are substantially free of structure. The blind portion 67 may terminate at locations spaced from the ends 13,14 of the fluid treatment pack 11. The blind portion 67 may comprise an impermeable wrap or sleeve or may comprise a portion of the side wall 306 of the housing 302 of the fluid treatment assembly 300, all of which may fit tightly around the exterior 65 of the fluid treatment pack 11, adjoining the outer folded ends of the pleats 15. A portion of the surround 64 with perforations 66 or other openings may extend from the blind portion 67 to each end 13,14.

The end sealing mechanism, e.g., the end caps 70,71, and the housing 302 may be arranged to direct feed fluid along a tangential fluid flow path 32 which extends along the outer surfaces of the legs 22,23 of the pleats 15. For example, feed fluid may pass from the feed port 303 generally radially inwardly through the perforation 66 in the surround 64 and the open outer ends 21 of the pleats 15 near one end 13 of the fluid treatment pack 11 to the regions 31 that are substantially free of structure. The feed fluid then passes generally axially along the tangential fluid flow path 32 via the regions 31 that are substantially free of structure to the other end 14 of the fluid treatment pack 11. The feed fluid then passes generally radially outwardly from the regions 31 that are substantially free of structure through the open outer ends 21 of the pleats 15 and the perforations 66 in the surround 64 to the concentrate port 304 of the fluid treatment assembly 300.

The core arrangement 53 may be without any barrier and may be perforated throughout its length or may have an outer surface texture which allows fluid to drain along the core arrangement. One or both end caps 70,71 may be an open end cap that communicates between the core arrangement 53 at the interior 54 of the fluid treatment pack 11 and the permeate port 305 of the fluid treatment assembly 300. One or more substances may pass from the tangential fluid flow path 32 and the regions 31 which are substantially free of structure through the fluid treatment medium 41 to the interior 54 of the fluid treatment pack 11 and the core arrangement 53, or vice versa, via the lateral fluid flow path 33.

The fluid treatment element 100 shown in FIGS. 6 and 7 may similarly be modified to provide a tangential fluid flow path within the pleats along the outer surface of the fluid treatment medium. For example, the geometry of the fluid treatment pack 11 shown in FIGS. 6 and 7 may be reversed. The fluid treatment pack may comprise a multilayer composite which includes a porous medium e.g., a drainage medium, positioned along the outer surface of the fluid treatment medium. The spacer arrangement, the regions occupied by the spacer arrangement, and the regions substantially free of structure may be positioned between the outer surface of the fluid treatment medium and the porous medium. For example, the spacer arrangement, the regions occupied by the spacer arrangement, and/or the regions substantially free of structure may adjoin the outer surface of the fluid treatment medium. The multilayer composite may further include a drainage medium positioned along the inner surface of the fluid treatment medium. The fluid treatment pack may be positioned between a surround and a core arrangement. For example, the surround 64, the end caps 70,71, and the core arrangement 53 of the fluid treatment element 301, as well as the housing 302 of the fluid treatment assembly 300, shown in FIGS. 12-14, may be associated with the fluid treatment pack.

The present invention is thus not restricted to the particular embodiments which have been described and/or illustrated but includes all embodiments and modifications that may fall within the scope of the claims.

1. A fluid treatment element comprising:
a fluid treatment pack which includes a fluid treatment medium, an axis, first and second opposite ends, and a plurality of pleats extending axially between the first and second ends, wherein each pleat has a folded end, an open end and first and second legs extending between the folded end and the open end of the pleat;
a spacer arrangement associated with the pleats of the fluid treatment pack to define a first region within each pleat that is occupied by the spacer arrangement and a second region within each pleat that is substantially free of structure;
a first fluid flow path which extends axially along the fluid treatment pack within the pleats, the first fluid flow path including the second region of each pleat; and
a second fluid flow path which extends through the pleated fluid treatment medium from or to the first fluid flow path.

2. The fluid treatment element of claim 1 wherein the spacer arrangement is positioned between the first and second legs of each pleat and the second region extends axially along the pleat between the first and second legs.

3. The fluid treatment element of claim 1 wherein the pleated fluid treatment pack comprises a composite including the fluid treatment medium and a porous medium and wherein the spacer arrangement is positioned between the fluid treatment medium and the porous medium and the second region extends axially along the pleat between the fluid treatment medium and the porous medium.

4. The fluid treatment element of claim 3 wherein the porous medium comprises a drainage medium.

5. The fluid treatment element of claim 1 wherein the region substantially free of structure adjoins the fluid treatment medium.

6. The fluid treatment element of claim 1 further comprising a sealing mechanism disposed at each end of the fluid treatment pack.

7. The fluid treatment element of claim 1 further comprising a surround fitted around the exterior of the fluid treatment pack and having openings only near one end of the fluid treatment pack.

8. A fluid treatment element comprising:
a hollow, generally cylindrical fluid treatment pack which includes an axis, an interior, first and second opposite ends, and a pleated composite, wherein the pleated composite defines a plurality of pleats extending axially between the first and second ends, each pleat having a folded outer end, an open inner end, and first and second legs extending between the folded outer end and the open inner end, and wherein the pleated composite includes a fluid treatment medium having an inner surface and an outer surface and a drainage medium positioned along the outer surface of the fluid treatment medium;
a spacer arrangement associated with the pleats of the fluid treatment pack inwardly from the inner surface of the fluid treatment medium, wherein the spacer arrangement includes a first spacer positioned proximate the first end of the fluid treatment pack, a second spacer positioned proximate the second end of the fluid treatment pack and a region which extends axially along each pleat between the first and second spacers and which is substantially free of structure;
a core arrangement positioned in the hollow interior of the fluid treatment pack and including a blind portion axially spaced from the first end and the second end of the fluid treatment pack, wherein the blind portion resists fluid flow radially inwardly from the axially extending regions of the fluid treatment pack; and
first and second end caps respectively sealed to the first and second ends of the fluid treatment pack, each end cap having a central opening which fluidly communicates with the axially extending regions of the pleats.

9. The fluid treatment element of claim 8 wherein the first and second spacers are positioned between the first and second legs of each pleat and the region substantially free of structure extends between the first and second legs.

10. The fluid treatment element of claim 8 wherein the composite further includes a porous medium positioned along the inner surface of the fluid treatment medium and wherein the first and second spacers are positioned between the fluid treatment medium and the porous medium and the region substantially free of structure extends between the fluid treatment medium and the porous medium.

11. The fluid treatment element of claim 10 wherein the porous medium comprises a drainage medium.

12. The fluid treatment element of claim 8 wherein the region substantially free of structure adjoins the fluid treatment medium.

13. A fluid treatment element comprising:
a generally cylindrical fluid treatment pack which includes an axis, and interior and exterior, first and second opposite ends and a pleated composite, wherein the pleated composite defines a plurality of pleats extending axially between the first and second ends, each pleat having a folded inner end, an open outer end, and first and second legs extending between the folded inner end and the open outer end, and wherein the pleated composite includes a fluid treatment medium having an inner surface and an outer surface and a drainage medium positioned along the inner surface of the fluid treatment medium;
a spacer arrangement associated with the pleats of the fluid treatment pack outwardly from the outer surface of the fluid treatment medium, wherein the spacer arrangement includes a first spacer positioned proximate the first end of the fluid treatment pack, a second spacer positioned proximate the second end of the fluid treatment pack, and a region which extends axially along each pleat between the first and second spacers and which is substantially free of structure;
an outer surround positioned around the exterior of the fluid treatment pack and including a blind portion axially spaced from the first end and the second end of the fluid treatment pack, wherein the blind portion resists fluid flow radially outwardly from the axially extending regions of the fluid treatment pack; and
first and second end caps respectively sealed to the first and second ends of the fluid treatment pack, each end cap having a central opening which fluidly communicates with the interior of the fluid treatment pack.

14. The fluid treatment element of claim 13 wherein the first and second spacers are positioned between the first and second legs of each pleat and the region substantially free of structure extends between the first and second legs.

15. The fluid treatment element of claim 13 wherein the composite further includes a porous medium positioned along the outer surface of the fluid treatment medium and wherein the first and second spacers are positioned between the fluid treatment medium and the porous medium and the region substantially free of structure extends between the fluid treatment medium and the porous medium.

16. The fluid treatment element of claim 15 wherein the porous medium comprises a drainage medium.

17. The fluid treatment element of claim 13 wherein the region substantially free of structure adjoins the fluid treatment medium.

18. A method of making a fluid treatment element comprising:
corrugating a fluid treatment medium to form a plurality of axially extending pleats, each pleat having a folded end, an open end, and first and second legs extending between the folded end and the open end;
forming the plurality of pleats into a generally cylindrical fluid treatment pack having first and second ends, wherein the pleats extend axially along the fluid treatment pack;
associating a spacer arrangement with the pleats to define a region within each pleat that extends axially and is substantially free of structure;
sealing the first and second ends of the fluid treatment pack to form a first fluid flow path that extends axially along the fluid treatment pack via the regions which are substantially free of structure and a second fluid flow path that extends through the fluid treatment medium to or from the first fluid flow path.

19. The method of claim 18 wherein associating the spacer arrangement with the pleats includes positioning the spacer arrangement proximate a surface of the fluid treatment medium and wherein corrugating the fluid treatment comprises corrugating the fluid treatment medium and the spacer arrangement.

20. The method of claim 18 wherein associating the spacer arrangement with the pleats comprises positioning the spacer arrangement within the pleats after corrugating the fluid treatment medium.

21. The method of any of claim 18 wherein associating the spacer arrangement with the pleats includes arranging the spacer arrangement to be positioned between the first and second legs of each pleat with the region substantially free of structure extending between the first and second legs.

22. The method of claim 18 wherein associating the spacer arrangement with the pleats includes forming a composite including the fluid treatment medium, a porous medium, and the spacer arrangement positioned between the fluid treatment medium and the porous medium and wherein corrugating the fluid treatment medium includes corrugating the composite and defining the region substantially free of structure between the fluid treatment medium and the porous medium.

23. The method of claim 22 wherein forming a composite including a porous medium includes forming a composite including a drainage medium.

24. A method of making a fluid a fluid treatment element comprising:
corrugating a composite to form a plurality of pleats, wherein the composite includes a fluid treatment medium having first and second opposite side edges and first and second opposite surfaces, a drainage medium positioned along the first surface of the fluid treatment medium, a spacer arrangement positioned along the second surface of the fluid treatment medium proximate the first edge, and a material positioned along the second surface of the fluid treatment medium adjacent to the spacer arrangement;
forming the corrugated composite into a generally cylindrical fluid treatment pack having first and second ends, wherein the pleats extend axially along the fluid treatment pack;
stripping the material from the corrugated composite to form a region within each pleat that is substantially free of structure; and
sealing the first and second ends of the fluid treatment pack to form a first fluid flow path that extends axially along the fluid treatment pack via the regions which are substantially free of structure and a second fluid flow path that extends through the fluid treatment medium from or to the first fluid flow path.

25. A process for treating a cellular solution comprising:
passing the cellular solution axially along a pleated fluid treatment element within the pleats, including directing the cellular solution axially along a region within each pleat that is substantially free of structure, and
passing one or more substances through a fluid treatment medium of the fluid treatment element from or to the cellular solution in the region substantially free of structure.

26. The process for treating the cellular solution of claim 25 wherein directing the cellular solution axially through a region substantially free of structure includes directing the cellular solution through a region substantially without structure between first and second legs of the pleats.

27. The process for treating the cellular solution of claim 25 wherein directing the cellular solution axially through a region substantially free of structure includes directing the cellular solution through a region substantially free of structure between a fluid treatment medium and a porous medium within each pleat.
